(19) United States
(12) Patent Application Publication
(10) Pub. No.: US 2023/0255431 A1
(43) Pub. Date: Aug. 17, 2023

(54) ROBOT CLEANER AND METHOD OF CONTROLLING THE SAME

(71) Applicant: LG ELECTRONICS INC., Seoul (KR)

(72) Inventor: Donghoon KWAK, Seoul (KR)

(73) Assignee: LG ELECTRONICS INC., Seoul (KR)

(21) Appl. No.: 18/014,256

(22) PCT Filed: Jun. 30, 2021
(86) PCT No.: PCT/KR2021/008219

§ 371 Date: Jan. 3, 2023

(30) Foreign Application Priority Data
Jul. 1, 2020 (KR) 10-2020-0081009

(51) Int. Cl. A47L 11/40

(52) U.S. Cl. CPC A47L 11/4011; A47L 11/4038; A47L 11/4069; A47L 2201/04

(57) ABSTRACT

Provided is a robot cleaner that includes a body having formed therein a space for accommodating a battery, a water container, and a motor, a pair of rotation plates that have coupled to lower sides thereof, mopping cloths facing a floor surface, and are rotatably disposed on a bottom surface of the body, and a virtual connection line connecting rotation axes of the pair of rotation plates to each other, in which a midpoint of the connection line moves while drawing a trajectory in a closed curve form on the floor surface in rotary traveling, thereby preventing a center of rotation of the robot cleaner from moving away from an origin of rotation.

### TECHNICAL FIELD

The present disclosure relates to a robot cleaner and a method of controlling the same, and more particularly, to a robot cleaner that rotates a mopping cloth thereof and is capable of traveling and cleaning the floor through a frictional force between the mopping cloth and the floor, and a method of controlling the robot cleaner.

### BACKGROUND ART

With the recent development of industrial technology, robot cleaners have been developed which clean, while traveling, a cleaning-required zone autonomously without user's manipulation. The robot cleaner includes a sensor capable of recognizing a space to be cleaned, a mopping cloth capable of cleaning the floor surface, etc., and travels while wiping the floor surface of the space recognized by the sensor with the mopping cloth, etc.

Among the robot cleaners, a wet robot cleaner is capable of wiping the floor surface with a mopping cloth containing moisture to effectively remove a foreign material strongly attached to the floor surface. The wet robot cleaner includes a water container, and water contained in the water container is supplied to the mopping cloth such that the mopping cloth containing moisture wipes the floor surface to effectively remove the foreign material strongly attached to the floor surface.

The wet robot cleaner may be structured such that the mopping cloth is formed in a circular form and contacts the floor surface while rotating to wipe the floor surface. In addition, the robot cleaner may travel in a particular direction by using a frictional force generated by contact of a plurality of mopping cloths with the floor surface during rotation.

Meanwhile, as the mopping cloth may more strongly wipe the floor surface with a greater frictional force between the mopping cloth and the floor surface, the robot cleaner may effectively clean the floor surface.

A wet-mopping cloth robot cleaner may need to intensively clean a specific area because liquid, etc. is spilled on a particular area. In this case, the robot cleaner may need to continuously clean the cleaning area while rotating at the same place.

In this regard, Korean patent publication no. 10-2016-0090569 (Aug. 1, 2016) discloses a robot cleaner that travels through rotation of one pair of wet-mopping cloths.

As one pair of wet mopping cloths rotate in the same direction at the same rotation speed, the robot cleaner may travel by rotating around the center of one pair of mopping cloths at the same place.

However, when the floor surface is not uniform, a foreign material is attached to one of the wet mopping cloths, or the pair of wet mopping cloths have different moisture contents, then frictional forces between the mopping cloths and the floor surface may become different from each other. In this case, the robot cleaner rotates out of the original rotation start point and cleans another position deviating from a target cleaning position.

### DISCLOSURE

### Technical Problem

The present disclosure has been conceived to improve the foregoing problems of conventional robot cleaner and control method of the same, and provides a robot cleaner and a method of controlling the same, whereby when the robot cleaner performs rotary traveling at the same place, the center of rotation of the robot cleaner is prevented from deviating from the origin of rotation.

Moreover, the present disclosure provides a robot cleaner and a method of controlling the same, whereby when a particular point has to be intensively cleaned, cleaning is performed without leaving the particular point, thereby improving the performance of cleaning.

### Technical Solution

According to an aspect of the present disclosure, a robot cleaner includes a body having formed therein a space for accommodating a battery, a water container, and a motor, a pair of rotation plates that have coupled to lower sides thereof, mopping cloths facing a floor surface, and are rotatably disposed on a bottom surface of the body, and a virtual connection line connecting rotation axes of the pair of rotation plates to each other.

A midpoint of the connection line may move while drawing a trajectory in a closed curve form on the floor surface in rotary traveling.

The midpoint of the connection line may move while drawing a trajectory in a spiral form on the floor surface in rotary traveling.

The midpoint of the connection line may move while drawing a trajectory in a flat circular form.

The midpoint of the connection line may move while drawing a trajectory in a rugby ball form.

The midpoint of the connection line may be located in an origin of rotation at the start of rotary traveling.

The origin of rotation may be located perpendicularly under the body when the body rotates once.

A distance between the origin of rotation and the midpoint may be maintained shorter than a distance between the midpoint and rotation axes of the rotation plates.

The pair of rotation plates may have the same rotation direction and have different rotation speeds.

Between the pair of rotation plates, a rotation speed of the rotation plate located far from the origin of rotation may be higher than a rotation speed of the rotation plate located close to the origin of rotation.

Between the pair of rotation plates, a rotation speed difference between the rotation plate located far from the origin of rotation and the rotation plate located close to the origin of rotation may increase, as a distance between the origin of rotation and the midpoint increases.

According to another aspect of the present disclosure, a method of controlling a robot cleaner that includes a pair of rotation plates having coupled to lower sides thereof a mopping cloth facing a floor surface and travels by rotating the pair of rotation plates, includes a rotary traveling operation of causing the robot cleaner to perform rotary traveling and a rotation correction operation of rotating the pair of rotation plates at different rotation speeds.

In the rotary traveling operation, the pair of rotation plates may be rotated in the same direction.

In the rotary traveling operation, the pair of rotation plates may be rotated at a same speed.

The method may further include a deviation determination operation of determining whether the robot cleaner deviates from a position corresponding to start of rotation.

In the rotation correction operation, a rotation speed difference between the pair of rotation plates may be increased as the robot cleaner moves away from a position corresponding to start of rotary traveling.

### Advantageous Effect

With the robot cleaner and the method of controlling the same according to the present disclosure described above, in rotary traveling at the same place with respect to the origin of rotation, the rotation plate disposed far from the origin of rotation may be rotated faster than the rotation plate disposed close to the origin of rotation, thereby preventing the center of rotation of the robot cleaner from moving away from the origin of rotation.

Moreover, by minimizing the overall radius by which the robot cleaner travels, cleaning may be possible without leaving a particular point requiring intensive cleaning.

### DESCRIPTION OF DRAWINGS

FIG. 1A is a perspective view of a robot cleaner according to an embodiment of the present disclosure;

FIG. 1B is a view of some components separated from the robot cleaner shown in FIG. 1A;

FIG. 1C is a rear view of the robot cleaner shown in FIG. 1A;

FIG. 1D is a bottom view of a robot cleaner according to an embodiment of the present disclosure;

FIG. 1E is an exploded perspective view of a robot cleaner according to an embodiment of the present disclosure;

FIG. 1F is a cross-sectional view schematically showing a robot cleaner and components thereof, according to an embodiment of the present disclosure;

FIG. 2 is a schematic view of a robot cleaner, viewed from top, according to an embodiment of the present disclosure;

FIG. 3 is a block diagram of a robot cleaner according to an embodiment of the present disclosure;

FIG. 4 is a flowchart of a method of controlling a robot cleaner, according to an embodiment of the present disclosure;

FIGS. 5 and 6 are views for roughly describing a path in which a robot cleaner rotates based on a method of controlling the robot cleaner according to an embodiment of the present disclosure;

FIG. 7 is a view for describing that rotation speeds and movement speeds of one pair of mopping cloths differ with an interval between a midpoint and an origin of rotation in a method of controlling a robot cleaner according to an embodiment of the present disclosure;

FIG. 8 is a view for describing a traveling trajectory when one pair of mopping cloths of a robot cleaner are rotated at the same rotation speed;

FIG. 9 is a view for describing a trajectory along which a robot cleaner travels while drawing a spiral on a floor surface based on a method of controlling the robot cleaner according to an embodiment of the present disclosure;

FIG. 10 is a schematic view for comparing traveling trajectories of FIGS. 8 and 9; and

FIG. 11 is a picture showing a traveling trajectory when a robot cleaner rotates one pair of mopping cloths at the same speed and a traveling trajectory when a mopping cloth located far from an origin of rotation is rotated faster than the other mopping cloth.

### MODE FOR INVENTION

Hereinafter, embodiments of the present disclosure will be described with reference to the accompanying drawings.

Various changes may be made to the present disclosure and the present disclosure may have various embodiments which will be described in detail with reference to the drawings. Such a description is not intended to limit the present disclosure to specified embodiments, and is construed as including all changes, equivalents, or substitutes included in the spirit and technical scope of the present disclosure.

To describe the present disclosure, terms such as first, second, and the like may be used to describe various components, but the components may not be limited to those terms. These terms may be used merely for the purpose of distinguishing one component from another component. For example, a first component may be named as a second component without departing from the right scope of the present disclosure, and similarly, the second component may be named as the first component.

The term “and/or” used herein includes any and all combinations of one or more of a plurality of associated listed items.

When a component is referred to as being “connected” or “accessed” to or by any other component, it should be understood that the component may be directly connected or accessed by the other component, but another new component may also be interposed between them. Contrarily, when a component is referred to as being “directly connected” or “directly accessed” to or by any other component, it should be understood that there is no component between the component and the other component.

The terms used in the present application are for the purpose of describing particular exemplary embodiments only and are not intended to be limiting. It is to be understood that the singular forms include plural references unless the context clearly dictates otherwise.

It will be further understood that the terms “comprises” and/or “has,” when used in this application, specify the presence of a stated feature, number, step, operation, component, element, or combination thereof, but do not preclude the presence or addition of one or more other features, numbers, steps, operations, components, elements, or combinations thereof.

All of the terms used herein including technical or scientific terms have the same meanings as those generally understood by an ordinary skilled person in the related art unless they are defined otherwise. The terms defined in a generally used dictionary may be interpreted as having meanings that are the same as or similar with the contextual meanings of the relevant technology and may not be interpreted as having ideal or exaggerated meanings unless they are clearly defined in the present application.

Moreover, the following embodiments are provided to more fully describe the present disclosure to those of ordinary skill in the art, and the shapes, sizes, etc., of components in the drawings may be exaggerated for clear description.

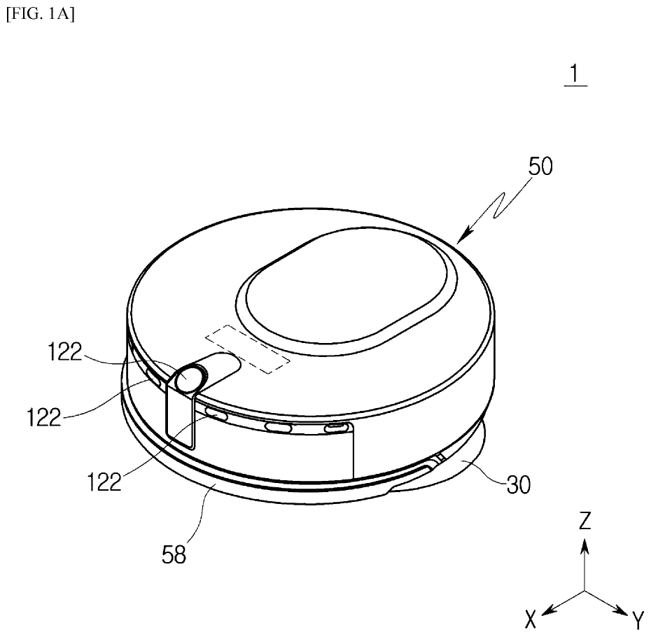

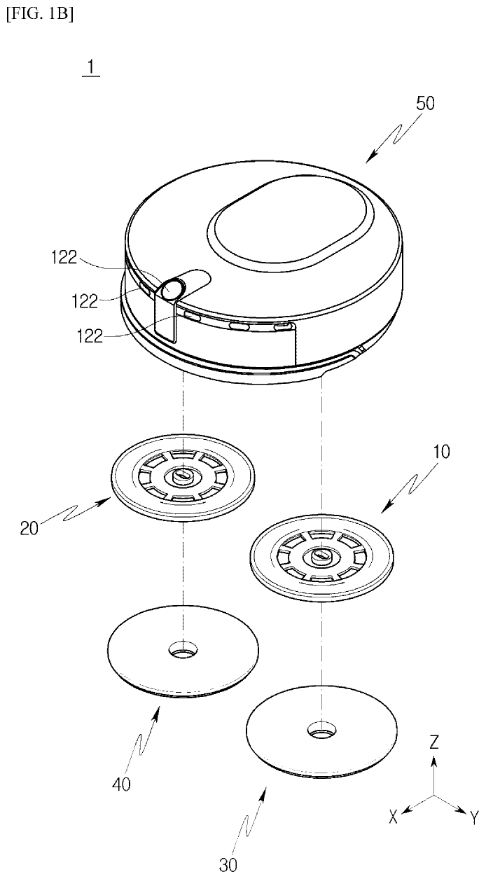

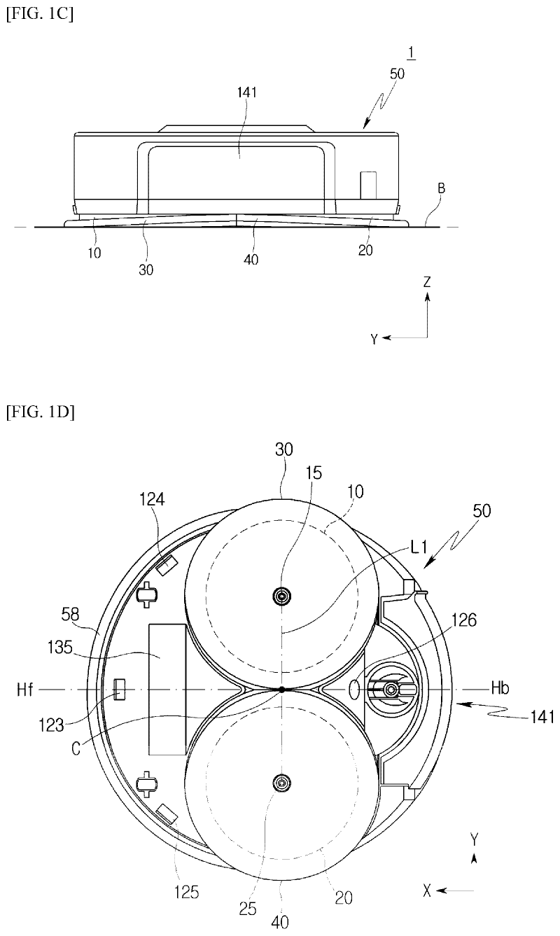

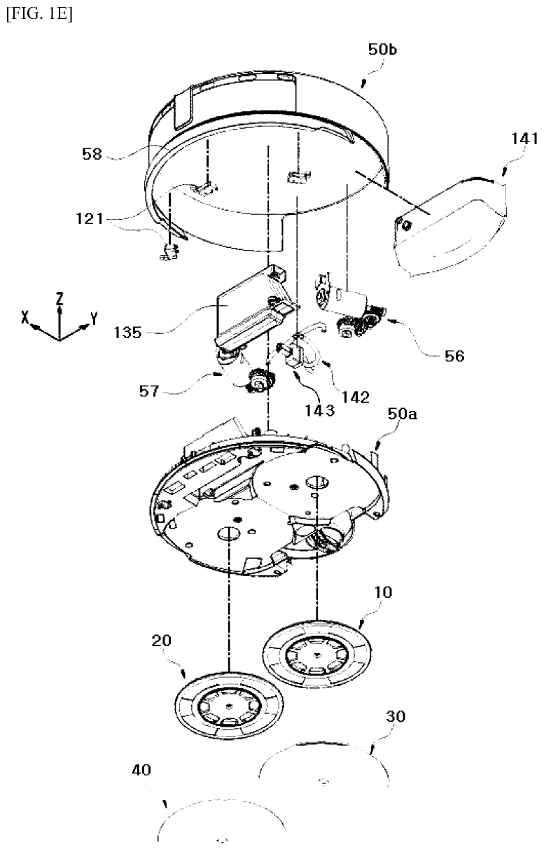

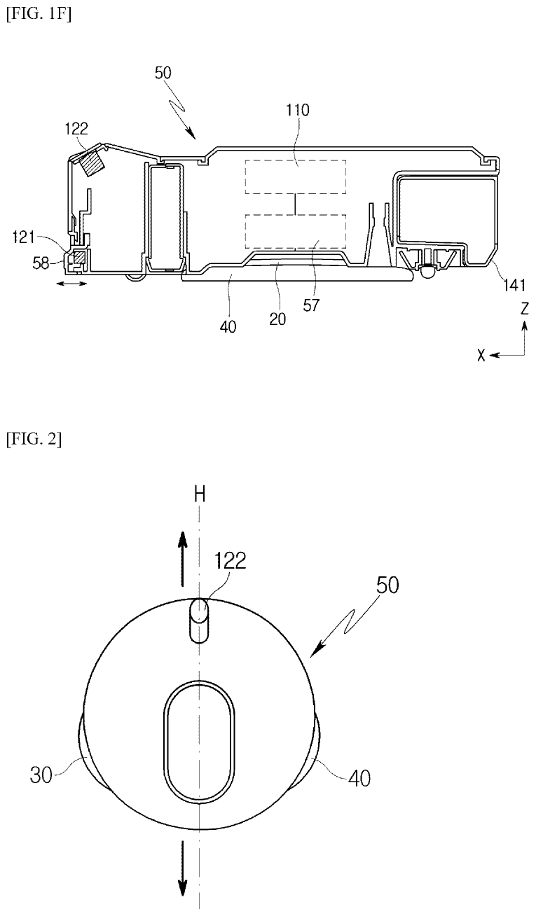

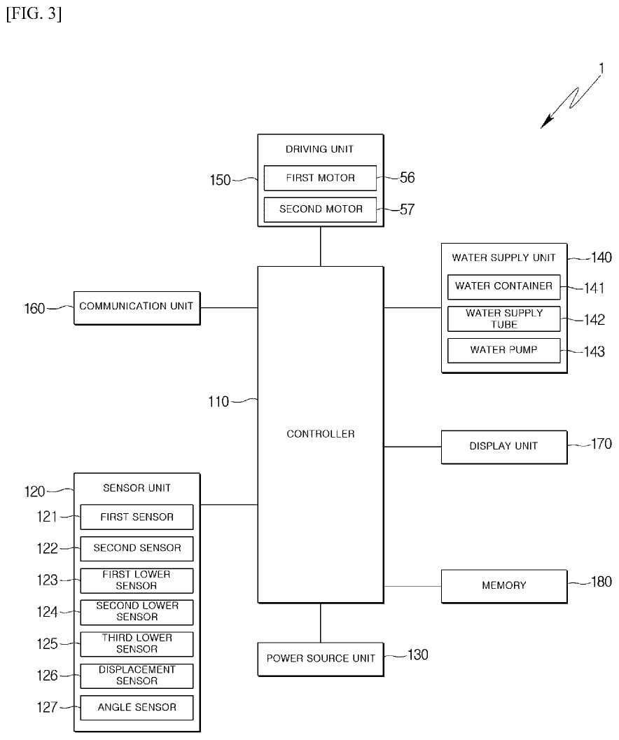

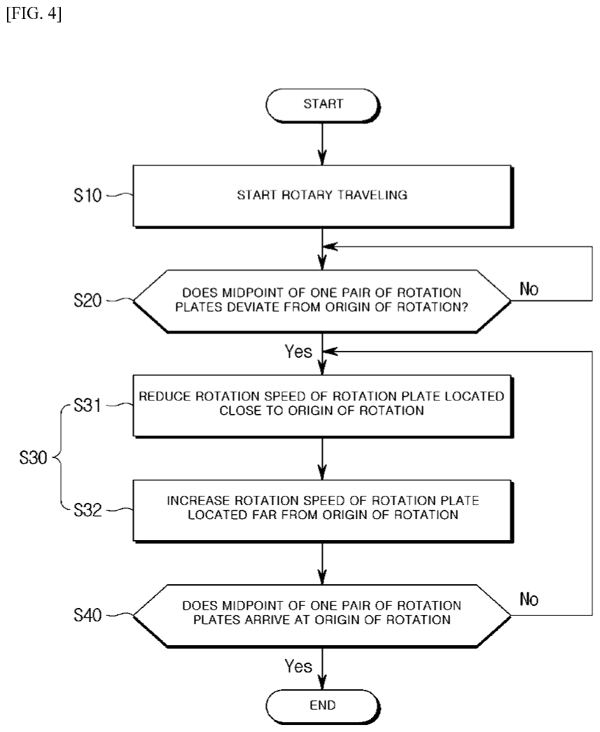

FIGS. 1A through 1F are structural views for describing a structure of a robot cleaner 1 controlled by a control device 5 according to the present disclosure, and FIG. 2 is a schematic view of the robot cleaner 1, viewed from top, according to an embodiment of the present disclosure.

More specifically, FIG. 1A is a perspective view of the robot cleaner 1, FIG. 1B is a view of some components separated from the robot cleaner 1, FIG. 1C is a rear view of the robot cleaner 1, FIG. 1D is a bottom view of the robot cleaner 1, FIG. 1E is an exploded perspective view of the robot cleaner 1, and FIG. 1F is an internal cross-sectional view of the robot cleaner 1.

Referring to FIGS. 1A through 1F and 2, a description will be made of a structure of the robot cleaner 1 according to the present disclosure.

The robot cleaner 1 may be placed on a floor and clean the floor by using a mopping cloth while moving along a floor surface B. Thus, hereinbelow, a description will be made by setting a top-bottom direction based on a state where the robot cleaner 1 is placed on the floor.

A side to which a first lower sensor 123 to be described later is coupled will be described as a front side with respect to a first rotation plate 10 and a second rotation plate 20.

A ‘lowest portion’ of each component described in the present disclosure may be a portion positioned lowest or a portion closest to the floor, when the robot cleaner 1 is used placed on the floor.

The robot cleaner 1 may include a body 50, the rotation plates 10 and 20, and mopping cloths 30 and 40. In this case, the rotation plates 10 and 20 may form a pair including the first rotation plate 10 and the second rotation plate 20, and the mopping cloths 30 and 40 may include a first mopping cloth 30 and a second mopping cloth 40.

The body 50 may form an overall appearance of the robot cleaner 1 or may be in a frame form. Respective parts of the robot cleaner 1 may be coupled to the body 50, and some parts of the robot cleaner 1 may be accommodated inside the body 50. The body 50 may be divided into a lower body 50a and an upper body 50b, and parts of the robot cleaner 1 including a battery 135, a water container 141, and motors 56 and 57 may be provided on a space formed by coupling between the lower body 50a and the upper body 50b (see FIG. 1E).

The first rotation plate 10 may be rotatably disposed on a bottom surface of the body 50 and may have the first mopping cloth 30 coupled to a lower side thereof.

The first rotation plate 10 may have a predetermined area and have a form such as a flat plate, a flat frame, etc. The first rotation plate 10 may be generally horizontally laid, such that a horizontal width (or diameter) thereof is sufficiently greater than a vertical height thereof. The first rotation plate 10 coupled to the body 50 may be parallel or inclined to the floor surface B. The first rotation plate 10 may be in a circular plate form, may have a bottom surface that is generally circular, and may be in a rotationally symmetric shape as a whole.

The second rotation plate 20 may be rotatably disposed on the bottom surface of the body 50, and may have the second mopping cloth 40 coupled to a lower side thereof.

The second rotation plate 20 may have a predetermined area and have a form such as a flat plate, a flat frame, etc. The second rotation plate 20 may be generally horizontally laid, such that a horizontal width (or diameter) thereof is sufficiently larger than a vertical height thereof. The second rotation plate 20 coupled to the body 50 may be parallel or inclined to the floor surface B. The second rotation plate 20 may be in a circular plate form, may have a bottom surface that is generally circular, and may be in a rotationally symmetric shape as a whole.

In the robot cleaner 1, the second rotation plate 20 may be formed identically or symmetrically to the first rotation plate 10. When the first rotation plate 10 is located in a left side of the robot cleaner 1, the second rotation plate 20 may be located in a right side of the robot cleaner 1, and in this case, the first rotation plate 10 and the second rotation plate 20 may be bilaterally symmetric to each other.

The first mopping cloth 30 may be coupled to the lower side of the first rotation plate 10 to face the floor surface B.

The first mopping cloth 30 may include a bottom surface having a predetermined area, which faces the floor, and may have a flat form. The first mopping cloth 30 may have such a form that a horizontal width (or diameter) thereof is sufficiently greater than a vertical height thereof. When the first mopping cloth 30 is coupled to the body 50, the bottom surface of the first mopping cloth 30 may be parallel or inclined to the floor surface B.

The bottom surface of the first mopping cloth 30 may be generally circular, and the first mopping cloth 30 may be in a rotationally symmetric shape as a whole. The first mopping cloth 30 may be attached to and detached from the bottom surface of the first rotation plate 10 and may be coupled to the first rotation plate 10 to rotate together with the first rotation plate 10.

The second mopping cloth 40 may be coupled to the lower side of the second rotation plate 20 to face the floor surface B.

The second mopping cloth 40 may include a bottom surface having a predetermined area, which faces the floor, and may have a flat form. The second mopping cloth 40 may have such a form that a horizontal width (or diameter) thereof is sufficiently greater than a vertical height thereof. When the second mopping cloth 40 is coupled to the body 50, the bottom surface of the second mopping cloth 40 may be parallel or inclined to the floor surface B.

The bottom surface of the second mopping cloth 40 may be generally circular, and the second mopping cloth 40 may be in a rotationally symmetric shape as a whole. The second mopping cloth 40 may be attached to and detached from the bottom surface of the second rotation plate 20 and may be coupled to the second rotation plate 20 to rotate together with the second rotation plate 20.

When the first rotation plate 10 and the second rotation plate 20 rotate in opposite directions and at the same speed, the robot cleaner 1 may move in a straight direction and move forward or backward. For example, when viewed from top, when the first rotation plate 10 rotates counterclockwise and the second rotation plate 20 rotates clockwise, the robot cleaner 1 may move forward.

When any one of the first rotation plate 10 and the second rotation plate 20 rotates, the robot cleaner 1 may change a direction and turn.

When the first rotation plate 10 and the second rotation plate 20 have different rotation speeds or rotate in the same direction, the robot cleaner 1 may move while changing a direction and may move in a curved direction.

The robot cleaner 1 may further include the first lower sensor 123.

The first lower sensor 123 may be formed in the lower side of the body 50 to sense a relative distance to the floor surface B. The first lower sensor 123 may be variously formed within a range in which the first lower sensor 123 is capable of sensing the relative distance between a point where the first lower sensor 123 is formed and the floor surface B.

When the relative distance, sensed by the first lower sensor 123, to the floor surface B (a vertical distance on the floor surface B or a distance in an inclined direction on the floor surface B) exceeds a predetermined value or a predetermined range, this case may correspond to a case where the floor surface B is suddenly lowered, such that the first lower sensor 123 may sense a cliff.

The first lower sensor 123 may include an optical sensor, a light-emitter that irradiates light, and a light-receiver to which reflected light is incident. The first lower sensor 123 may include an infrared sensor.

The first lower sensor 123 may be referred to as a cliff sensor.

The robot cleaner 1 may further include a second lower sensor 124 and a third lower sensor 125.

When a virtual line connecting the center of the first rotation plate 10 with the center of the second rotation plate 20 in a horizontal direction (a direction parallel to the floor surface B) is a connection line L1, the second lower sensor 124 and the third lower sensor 125 may be formed in the lower side of the body 50 in the same side as the first lower sensor 123 with respect to the connection line L1 and sense a relative distance to the floor surface B (see FIG. 1D).

The third lower sensor 125 may be formed opposite to the second lower sensor 124 with respect to the first lower sensor 123.

Each of the second lower sensor 124 and the third lower sensor 125 may be variously formed within a range in which they are capable of sensing a relative distance to the floor surface B. Each of the second lower sensor 124 and the third lower sensor 125 may be formed identically to the first lower sensor 123 except for a position where each of them is formed.

The robot cleaner 1 may further include the first motor 56, the second motor 57, the battery 135, the water container 141, and a water supply tube 142.

The first motor 56 may be coupled to the body 50 to rotate the first rotation plate 10. More specifically, the first motor 56 may include an electric motor coupled to the body 50, and one or more gears may be connected to the first motor 56 to deliver a rotational force to the first rotation plate 10.

The second motor 57 may be coupled to the body 50 to rotate the second rotation plate 20. More specifically, the second motor 57 may include an electric motor coupled to the body 50, and one or more gears may be connected to the second motor 57 to deliver a rotational force to the second rotation plate 20.

As such, in the robot cleaner 1, the first rotation plate 10 and the first mopping cloth 30 may rotate by the operation of the first motor 56, and the second rotation plate 20 and the second mopping cloth 40 may rotate by the operation of the second motor 57.

The second motor 57 may be symmetric (bilaterally symmetric) to the first motor 56.

The battery 135 may be coupled to the body 50 to supply power to other components of the robot cleaner 1. The battery 135 may supply power to the first motor 56 and the second motor 57.

The battery 135 may be charged by an external power source, and to this end, a charging terminal for charging the battery 135 may be provided in a side of the body 50 or in the battery 135.

In the robot cleaner 1, the battery 135 may be coupled to the body 50.

The water container 141 may be in a container form having an inner space for storing liquid such as water therein. The water container 141 may be fixedly coupled to the body 50 or coupled attachably/detachably to/from the body 50.

In the robot cleaner 1, the water supply tube 142 may be in a tube or pipe form and may be connected to the water container 141 to allow liquid in the water container 141 to flow therethrough. An opposite end of the water supply tube 142, which is connected to the water container 141, may be positioned in upper sides of the first rotation plate 10 and the second rotation plate 20, such that the liquid in the water container 141 may be supplied to the first mopping cloth 30 and the second mopping cloth 40.

In the robot cleaner 1, the water supply tube 142 may have a form in which one pipe is branched into two parts and an end of any one of the parts may be positioned in the upper side of the first rotation plate 10 and an end of the other part may be positioned in the upper side of the second rotation plate 20.

The robot cleaner 1 may include a separate water pump 143 for liquid movement through the water supply tube 142.

The robot cleaner 1 may further include a bumper 58, a first sensor 121, and a second sensor 122.

The bumper 58 may be coupled along an edge of the body 50 and move relative to the body 50. For example, the bumper 58 may be coupled to the body 50 to reciprocate in a direction close to the center of the body 50.

The bumper 58 may be coupled along a part of the edge of the body 50 or the entire edge of the body 50.

The first sensor 21 may be coupled to the body 50 and sense movement (relative movement) of the bumper 58 relative to the body 50. The first sensor 121 may be formed using a microswitch, a photo interrupter, a tact switch, etc.

The second sensor 122 may be coupled to the body 50 and sense a relative distance to an obstacle. The second sensor 122 may include a distance sensor.

Meanwhile, the robot cleaner 1 according to an embodiment of the present disclosure may further include a displacement sensor 126.

The displacement sensor 126 may be disposed on the bottom surface (rear surface) of the body 50 and measure a distance the robot cleaner 1 moves along the floor surface B.

For example, the displacement sensor 126 may use an optical flow sensor (OFS) that obtains image information of the floor surface by using light. Herein, the OFS may include an image sensor that obtains the image information of the floor surface by capturing an image of the floor surface and one or more light sources that adjust the amount of light.

An operation of the displacement sensor 126 will be described using the OFS as an example. The OFS may be provided on the bottom surface (rear surface) of the robot cleaner 1 to capture an image in a downward direction, i.e., an image of the floor surface. The OFS may convert a downward image input from the image sensor to generate downward image information of a predetermined format.

With this configuration, the displacement sensor 126 may detect a relative position of the robot cleaner 1 with respect to a predetermined point, regardless of slippage. That is, by allowing the downward direction of the robot cleaner 1 to be observed using the OFS, position correction corresponding to slippage may be possible.

Meanwhile, the robot cleaner 1 according to an embodiment of the present disclosure may further include an angle sensor 127.

The angle sensor 127 may be disposed inside the body 50 and measure a movement angle of the body 50.

For example, the angle sensor 127 may use a gyro sensor that measures a rotation speed of the body 50. The gyro sensor may detect a direction of the robot cleaner 1 by using the rotation speed.

With this configuration, the angle sensor 127 may detect an angle of the traveling direction of the robot cleaner 1 with respect to a predetermined virtual line.

Meanwhile, the present disclosure may further include the virtual connection line L1 that connects rotation axes of one pair of rotation plates 10 and 20 to each other. More specifically, the connection line L1 may mean a virtual line that connects the rotation axis of the first rotation plate 10 to the rotation axis of the second rotation plate 20.

The connection line L1 may be a reference that divides the robot cleaner 1 into a front and a rear. For example, a direction in which the first lower sensor 123 is disposed with respect to the connection line L1 may be referred to as the front of the robot cleaner 1 and a direction in which the water container 141 is disposed with respect to the connection line L1 may be referred to as the rear of the robot cleaner 1.

Thus, the first lower sensor 123, the second lower sensor 124, and the third lower sensor 125 may be disposed in a front lower side of the body 50 with respect to the connection line L1, the first sensor 121 may be disposed in an inner side of a front outer circumferential surface of the body 50, and the second sensor 122 may be disposed in a front upper side of the body 50. The battery 135 may be insertedly coupled to the front of the body 50 with respect to the connection line L1 in a direction perpendicular to the floor surface B. The displacement sensor 126 may be disposed in the rear of the body 50 with respect to the connection line L1.

Meanwhile, the present disclosure may further include a virtual traveling direction line H that perpendicularly intersects with the connection line L1 at a midpoint C of the connection line L1 and extends in parallel to the floor surface B. More specifically, the traveling direction line H may include a forward traveling direction line Hf that extends in parallel to the floor surface B toward a direction in which the battery 135 is disposed with respect to the connection line L1 and a backward traveling direction line Hb that extends in parallel to the floor surface B toward a direction in which the water container 141 is disposed with respect to the connection line L1. The battery 135 and the first lower sensor 123 may be disposed on the forward traveling direction line Hf, and the displacement sensor 126 and the water container 141 may be disposed on the backward traveling direction line Hb. The first rotation plate 10 and the second rotation plate 20 may be disposed symmetric (line-symmetric) to each other around (with respect to) the traveling direction line H.

With this configuration, the traveling direction line H may mean a direction in which the robot cleaner 1 travels.

Meanwhile, to help understanding, the front end of the robot cleaner 1 according to the present disclosure will be described as below. The front end of the robot cleaner 1 in the present disclosure may mean the farthest point protruding forward along the horizontal direction with respect to the connection line L1. For example, the front end of the robot cleaner 1 may mean a point through which the forward traveling direction line Hf passes on an outer circumferential surface of the bumper 58.

A rear end of the robot cleaner 1 may mean the farthest point protruding backward along the horizontal direction with respect to the connection line L1. For example, the rear end of the robot cleaner 1 may mean a point through which the backward traveling direction line Hb passes on an outer circumferential surface of the water container 141.

Meanwhile, a block diagram of the robot cleaner shown in FIG. 1 of the present disclosure is shown in FIG. 3.

Referring to FIG. 3, the robot cleaner 1 may include a controller 110, a sensor unit 120, a power source unit 130, a water supply unit 140, a driving unit 150, a communication unit 160, a display unit 170, and memory 180. The components shown in the block diagram of FIG. 2 are not essential to implement the robot cleaner 1, and the robot cleaner 1 described herein may include components that are more or less than the above-described components.

The controller 110 may be disposed inside the body 50, and may be connected to a control device (not shown) by wireless communication through the communication unit 160 to be described later. In this case, the controller 110 may transmit various data regarding the robot cleaner 1 to the connected control device (not shown). The controller 110 may receive input data from the connected control device and store the same. Herein, the data input from the control device may be a control signal for controlling at least one function of the robot cleaner 1.

That is, the robot cleaner 1 may receive a control signal based on a user input from the control device and operate according to the received control signal.

The controller 110 may control overall operations of the robot cleaner 1. The controller 110 may control the robot cleaner 1 to perform a cleaning operation while autonomously traveling on a cleaning surface to be cleaned, based on configuration information stored in the memory 180 to be described later.

Meanwhile, straight-traveling control of the controller 110 will be described later in the present disclosure.

The sensor unit 120 may include one or more of the first lower sensor 123, the second lower sensor 124, the third lower sensor 125, the first sensor 121, and the second sensor 122 of the foregoing robot cleaner 1.

That is, the sensor unit 120 may include a plurality of different sensors capable of sensing a surrounding environment of the robot cleaner 1, and information about the surrounding environment of the robot cleaner 1 sensed by the sensor unit 120 may be transmitted to the control device by the controller 110. Herein, the information about the surrounding environment may include, for example, existence of an obstacle, sensing of a cliff, sensing of collision, etc.

The controller 110 may control operations of the first motor 56 and/or the second motor 57 based on information from the first sensor 121. For example, when the bumper 58 contacts an obstacle during traveling of the robot cleaner 1, a contact position of the bumper 58 may be recognized by the first sensor 121 and the controller 110 may control the operations of the first motor 56 and/or the second motor 57 to leave the contact position.

Based on information from the second sensor 122, when a distance between the robot cleaner 1 and an obstacle is less than or equal to a predetermined value, the controller 110 may control the operations of the first motor 56 and/or the second motor 57 such that the robot cleaner 1 changes the traveling direction thereof or moves in a direction away from the obstacle.

According to a distance sensed by the first lower sensor 123, the second lower sensor 124, or the third lower sensor 125, the controller 110 may control the operations of the first motor 56 and/or the second motor 57 such that the robot cleaner 1 stops or changes the traveling direction thereof.

According to a distance sensed by the displacement sensor 126, the controller 110 may control the operations of the first motor 56 and/or the second motor 57 such that the robot cleaner 1 changes the traveling direction thereof. For example, when the robot cleaner 1 deviates from an input traveling path or traveling pattern due to slippage occurring therein, the displacement sensor 126 may measure a distance deviating from the input traveling path or traveling pattern, and the controller 110 may control the operations of the first motor 56 and/or the second motor 57 to compensate for the deviating distance.

According to an angle sensed by the angle sensor 127, the controller 110 may control the operations of the first motor 56 and/or the second motor 57 such that the robot cleaner 1 changes the traveling direction thereof. For example, when the robot cleaner 1 deviates from the input traveling direction due to slippage occurring therein, the angle sensor 127 may measure an angle deviating from the input traveling direction, and the controller 110 may control the operations of the first motor 56 and/or the second motor 57 to compensate for the deviating angle.

Meanwhile, the power source unit 130 may receive external power or internal power and supply power required for operations of components, under control of the controller 110. The power source unit 130 may include the battery 135 of the robot cleaner 1.

The water supply unit 140 may include the water container 141, the water supply tube 142, and the water pump 143 of the above-described robot cleaner 1. The water supply unit 140 may adjust the amount of supply of liquid (water) to the first mopping cloth 30 and the second mopping cloth 40, according to a control signal of the controller 110. The controller 110 may control a driving time of a motor for driving the water pump 143 to adjust the amount of water supply.

The driving unit 150 may include the first motor 56 and the second motor 57 of the robot cleaner 1 described above. The driving unit 150 may cause the robot cleaner 1 to rotate or move straight according to the control signal of the controller 110.

The communication unit 160 may be disposed inside the body 50, and may include at least one module enabling wireless communication between the robot cleaner 1 and a wireless communication system, between the robot cleaner 1 and a preset peripheral device, or between the robot cleaner 1 and a preset external server.

For example, at least one module may include at least one of an infrared (IR) module for IR communication, an ultrasonic module for ultrasonic communication, or a short-range communication module such as a wireless fidelity (WiFi) module or a Bluetooth module. Alternatively, a wireless Internet module may be included to transmit or receive data to or from a preset device through various wireless techniques such as a wireless local area network (WLAN), WiFi, etc.

Meanwhile, the display unit 170 may display information to be provided to a user. For example, the display unit 170 may include a display that displays a screen. In this case, the display may be exposed on a top surface of the body 50.

The display unit 170 may also include a speaker that outputs sound. For example, the speaker may be built in the body 50. In the body 50, a hole may be formed to pass sound therethrough at a position corresponding to a position of the speaker. A source of sound output through the speaker may be sound data stored previously in the robot cleaner 1. For example, the previously stored sound data may regard to a voice guide corresponding to each function of the robot cleaner 1 or an alert sound indicating an error.

The display unit 170 may include any one of a light-emitting diode (LED), a liquid crystal display (LCD), a plasma display panel (PDP), and an organic light-emitting diode (OLED).

The memory 180 may include various data for driving and operations of the robot cleaner 1. The memory 180 may include application programs and related various data for autonomous traveling of the robot cleaner 1. The memory 180 may also store respective data sensed by the sensor unit 120 and include setting information, etc., about user-selected or user-input settings (values) (e.g., a cleaning reservation time, a cleaning mode, the amount of water supply, an LED brightness level, a volume of the alert sound, etc.).

The memory 180 may include information about a cleaning surface to be cleaned, currently given to the robot cleaner 1. For example, the information about the cleaning surface to be cleaned may be map information autonomously mapped by the robot cleaner 1. The map information, i.e., a map may include various information set by the user for each area of the cleaning surface to be cleaned.

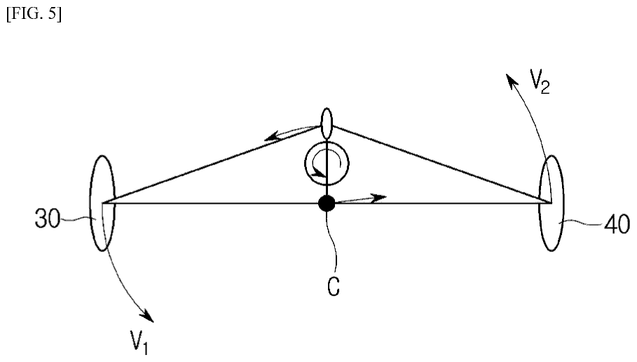

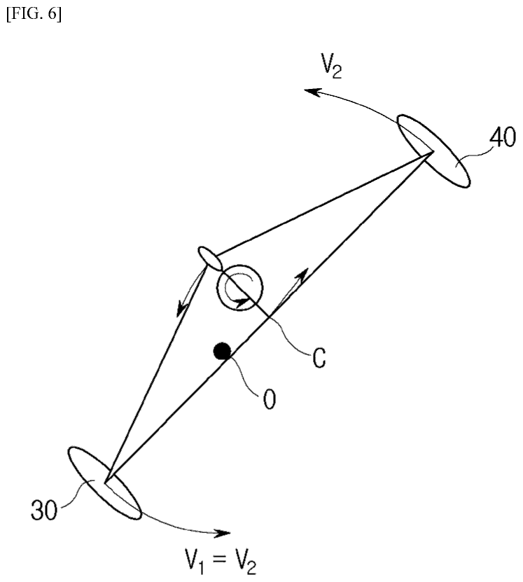

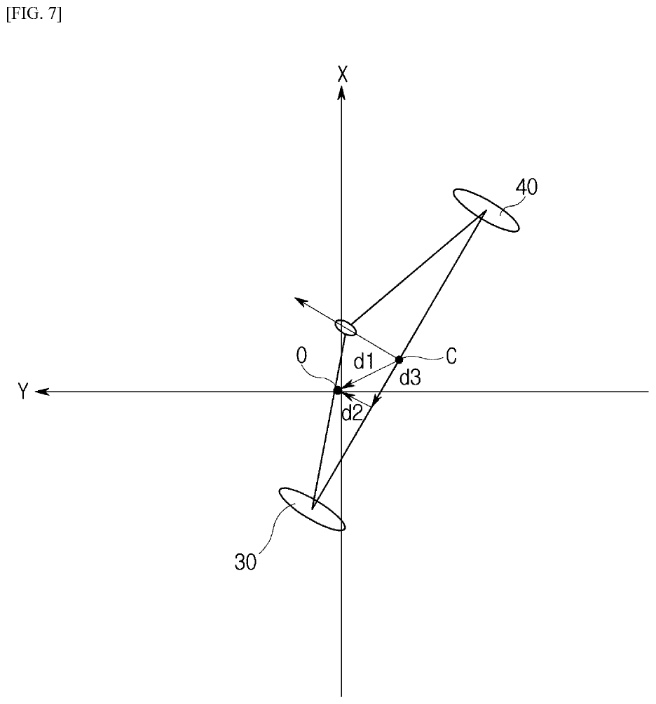

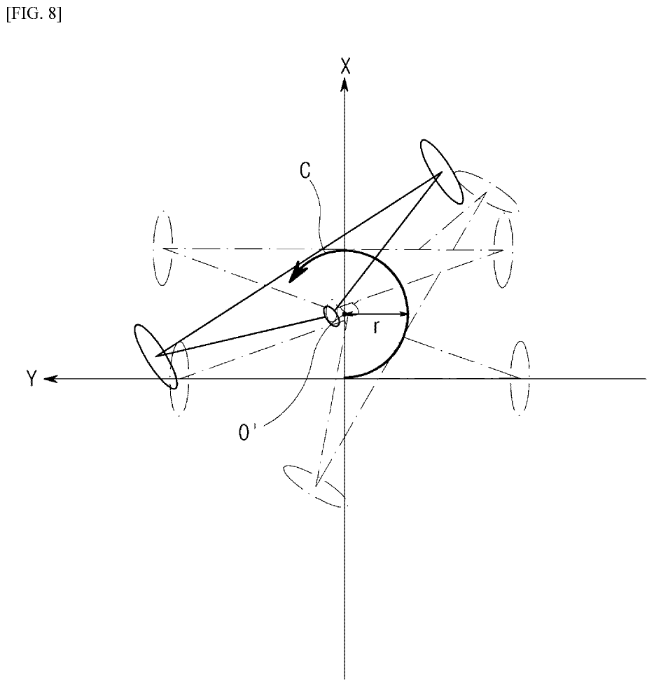

Meanwhile, FIG. 4 is a flowchart of a method of controlling a robot cleaner according to an embodiment of the present disclosure, FIGS. 5 and 6 are views for roughly describing a path in which a robot cleaner rotates based on the method of controlling the robot cleaner according to an embodiment of the present disclosure, and FIG. 7 is a view for describing that rotation speeds and movement speeds of one pair of mopping cloths differ with an interval between a midpoint and an origin of rotation based on the method of controlling the robot cleaner according to an embodiment of the present disclosure.

Referring to FIGS. 1D, 1E, and 4 through 7, a description will be made of the method of controlling the robot cleaner, according to an embodiment of the present disclosure.

The method of controlling a robot cleaner according to an embodiment of the present disclosure may include rotary traveling operation S10 of rotating the robot cleaner at the same place.

In rotary traveling operation S10, the controller 110 may rotate one pair of rotation plates 10 and 20 in the same direction. That is, the controller 110 may control the first motor 56 and the second motor 57 to operate in the same direction. Thus, the first mopping cloth 30 and the second mopping cloth 40 may be rotated in the same direction.

For example, when viewed down from top perpendicularly to the ground (a floor surface), to rotate the robot cleaner 1 counterclockwise, the controller 110 may drive the first motor 56 and the second motor 57 to rotate the first rotation plate 10 and the second rotation plate 20 clockwise. Thus, the first mopping cloth 30 and the second mopping cloth 40 may rotate clockwise, together with the first rotation plate 10 and the second rotation plate 20, and relatively rotate while being rubbed against the floor surface B, thus rotating the robot cleaner 1 counterclockwise.

In another example, when viewed down from top perpendicularly to the ground (the floor surface), to rotate the robot cleaner 1 clockwise, the controller 110 may drive the first motor 56 and the second motor 57 to rotate the first rotation plate 10 and the second rotation plate 20 counterclockwise. Thus, the first mopping cloth 30 and the second mopping cloth 40 may rotate counterclockwise, together with the first rotation plate 10 and the second rotation plate 20, and relatively rotate while being rubbed against the floor surface B, thus rotating the robot cleaner 1 clockwise.

In rotary traveling operation S10, at the start of rotary traveling, the controller 110 may rotate one pair of rotation plates 10 and 20 at the same speed.

That is, in rotary traveling operation S10, the controller 110 may drive the first motor 56 and the second motor 57 with the same output (see FIGS. 5 and 6).

In rotary traveling operation S10, a relative movement speed v1 of the first mopping cloth 30 with respect to the floor surface B and a relative movement speed v2 of the second mopping cloth 40 with respect to the floor surface B may have the same magnitude (absolute value).

In principle, when a special external force is not applied, upon rotation of the first rotation plate 10 and the second rotation plate 20 of the robot cleaner 1 at the same rotation speed in the same rotation direction, the robot cleaner 1 may rotate at the same place, around the midpoint C of the connection line L1 connecting a rotation axis 15 of the first rotation plate 10 to a rotation axis 25 of the second rotation plate 20 as a rotation axis.

That is, in the start of rotary traveling to which the special external force is not applied, the midpoint C of the robot cleaner 1 may be an origin O of rotation at the same place.

Meanwhile, once the robot cleaner 1 starts traveling, a structure such as a caster, an auxiliary wheel, etc., disposed on the bottom surface of the body 50 may be rubbed against the floor surface B. Moreover, due to existence of a foreign material on the floor surface B, the foreign material may be put on only one of the pair of mopping cloths 30 and 40. Moreover, a difference in moisture content may occur between the pair of mopping cloths 30 and 40. A position of the overall center of gravity of the robot cleaner 1 may also be changed with the amount of water stored in the water container 141.

When such a traveling situation occurs, an external force may be instantly applied to the robot cleaner 1. That is, as frictional forces between the floor surface B and the mopping cloths 30 and 40 may become non-uniform, a frictional force may be generated between the bottom surface of the body 50 and the floor surface B, or the center of gravity shakes, a centrifugal force may be instantly generated.

Thus, upon the start of traveling of the robot cleaner 1, the center of rotation of the robot cleaner 1 may deviate from the origin O of rotation, thus being newly generated (see FIGS. 5 and 6). The midpoint C located in the existing center of rotation may move, drawing a circle around a new center O′ of rotation, when viewed from top (see FIG. 8).

The method of controlling a robot cleaner according to the present disclosure may include deviation determination operation S20.

In deviation determination operation S20, the controller 110 may determine whether the rotation axis of the robot cleaner 1 deviates from the origin O of rotation by determining whether the current midpoint C moves away from the midpoint C in rotary traveling operation S10, i.e., the origin O of rotation.

More specifically, the controller 110 may measure a distance difference of the current midpoint C from the origin O of rotation, and determine based on the measured distance difference whether the robot cleaner 1 deviates from the origin O of rotation.

That is, after the start of traveling of the robot cleaner 1 in rotary traveling operation S10, when the new center O′ of rotation is generated due to friction with the floor surface B, etc., the midpoint C may move, drawing a circle around the new center O′ of rotation as a rotation axis. At this time, a distance between the new center O′ of rotation and the midpoint C may be a rotation radius r. Thus, a distance difference may occur in a position of the current midpoint C from the origin O of rotation at which the midpoint C is located at the start of rotation.

Therefore, in deviation determination operation S20, after rotary traveling operation S10, by measuring the distance difference between the origin O of rotation and the current midpoint C, it may be determined whether the rotation axis of the robot cleaner 1 deviates from the origin O of rotation.

The method of controlling a robot cleaner according to the present disclosure may include rotation correction operation S30.

In rotation correction operation S30, the controller 110 may rotate the pair of rotation plates 10 and 20 at different rotation speeds. More specifically, the controller 110 may rotate the pair of rotation plates 10 and 20 in the same rotation direction at different rotation speeds.

That is, in rotation correction operation S30, the controller 110 may control outputs of the first motor 56 and the second motor 57 to be different from each other.

In rotation correction operation S30, the relative movement speed v1 of the first mopping cloth 30 with respect to the floor surface B and the relative movement speed v2 of the second mopping cloth 40 with respect to the floor surface B may be different from each other.

More specifically, in rotation correction operation S30, the controller 110 may rotate the rotation plate located far from the origin O of rotation between the pair of rotation plates 10 and 20 faster than the other rotation plate located close to the origin O of rotation.

That is, in rotation correction operation S30, the controller 110 may control the output of the motor located far from the origin O of rotation to be greater than the output of the motor located close to the origin O of rotation.

Thus, in rotation correction operation S30, the relative movement speed of the mopping cloth located far from the origin O of rotation with respect to the floor surface B may be higher than the relative movement speed of the mopping cloth located close to the origin O of rotation with respect to the floor surface B.

For example, as shown in FIG. 7, when viewed from above the ground, when the midpoint C moves away from the origin O of rotation as the robot cleaner 1 rotates counterclockwise, the first mopping cloth 30 may be moved close to the origin O of rotation and the second mopping cloth 40 may be moved away from the origin O of rotation. In this case, the controller 110 may reduce the output of the first motor 56 and increase the output of the second motor 57. Thus, the rotation speed of the first rotation plate 10 may be reduced in operation S31, and the rotation speed of the second rotation plate 20 may be increased in operation S32. As a result, an absolute value of the relative movement speed v1 of the first mopping cloth 30 with respect to the floor surface B may decrease, and an absolute value of the relative movement speed v2 of the second mopping cloth 40 with respect to the floor surface B may increase.

Meanwhile, in the present disclosure, the increase of the rotation speed of the rotation plate located far from the origin O of rotation and the reduction of the rotation speed of the rotation plate located close to the origin O of rotation may be performed simultaneously, or any one of them may be performed first.

In rotation correction operation S30, the controller 110 may increase a rotation speed difference between the pair of rotation plates 10 and 20 as the position of the midpoint C of the robot cleaner 1 moves away from the origin O of rotation.

More specifically, in rotation correction operation S30, as the distance between the midpoint C and the origin O of rotation increases, the controller 110 may further increase the rotation speed of the rotation plate located far from the origin O of rotation between the pair of rotation plates 10 and 20 and further reduce the rotation speed of the rotation plate located close to the origin O of rotation.

That is, in rotation correction operation S30, as the distance between the midpoint C and the origin O of rotation increases, the controller 110 may further increase the output of the motor located far from the origin O of rotation and further reduce the output of the motor located close to the origin O of rotation.

Thus, in rotation correction operation S30, as the distance between the midpoint C and the origin O of rotation increases, the relative movement speed of the mopping cloth located far from the origin O of rotation with respect to the floor surface B may be higher than the relative movement speed of the mopping cloth located close to the origin O of rotation with respect to the floor surface B.

For example, as shown in FIG. 7, when viewed from above the ground, when the midpoint C gradually moves away from the origin O of rotation as the robot cleaner 1 rotates counterclockwise, the first mopping cloth 30 may be gradually moved close to the origin O of rotation and the second mopping cloth 40 may be gradually moved away from the origin O of rotation. In this case, the controller 110 may further reduce the output of the first motor 56 and further increase the output of the second motor 57. Thus, the rotation speed of the first rotation plate 10 may be further reduced in operation S31, and the rotation speed of the second rotation plate 20 may be further increased in operation S32. As a result, the absolute value of the relative movement speed v1 of the first mopping cloth 30 with respect to the floor surface B may further decrease, and the absolute value of the relative movement speed v2 of the second mopping cloth 40 with respect to the floor surface B may further increase.

With such a configuration, according to the present disclosure, when the midpoint C deviates from the origin O of rotation, the midpoint C may be returned to the origin O of rotation by controlling the rotation speeds of the pair of rotation plates 10 and 20 differently.

This will be described as below in more detail with reference to FIG. 7.

The midpoint C may be located in the origin O of rotation before the start of rotation, and may move drawing a circular arc on the floor surface B around the new center O′ of rotation upon the start of rotary traveling in rotary traveling operation S10. In this case, the controller 110 may measure a distance dl between the midpoint C and the origin O of rotation through the displacement sensor 126, and control the rotation speeds of the first rotation plate 10 and the second rotation plate 20 to move the midpoint C back to the origin O of rotation.

To move the midpoint C back to the origin O of rotation, a vector sum of relative movement speeds of the mopping cloths 30 and 40 with respect to the floor surface B has to coincide with a direction (a direction of d1) from the midpoint C toward the origin O of rotation.

That is, the direction (the direction of d1) from the midpoint C toward the origin O of rotation may be decomposed into component vectors perpendicular to the connection line L1, i.e., a left-right vector d3 of the robot cleaner 1 disposed along the connection line L1 and a front-back vector d2 disposed perpendicular to the connection line L1.

The controller 110 may control a rotation speed difference between the first rotation plate 10 and the second rotation plate 20 according to magnitudes of the left-right vector d3 and the front-back vector d2. Thus, a sum of a vector for relative movement between the first mopping cloth 30 and the floor surface B and a vector for relative movement between the second mopping cloth 40 and the floor surface B may be the same as a vector of the direction (the direction of d1) from the midpoint C toward the origin O of rotation.

Thus, as a speed difference between the rotation plate disposed far from the origin O of rotation and the rotation plate disposed close to the origin O of rotation increases when the midpoint C moves away from the origin O of rotation through rotation correction operation S30, the midpoint C may be quickly returned toward the origin O of rotation.

Meanwhile, in the current embodiment, rotation correction operation S30 may be continuously performed until the midpoint C of the robot cleaner 1 arrives at the origin O of rotation, in operation S40.

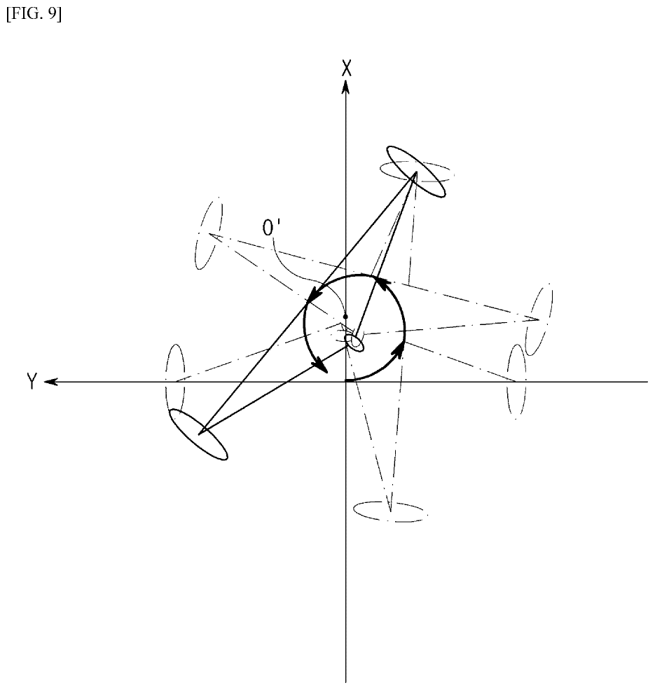

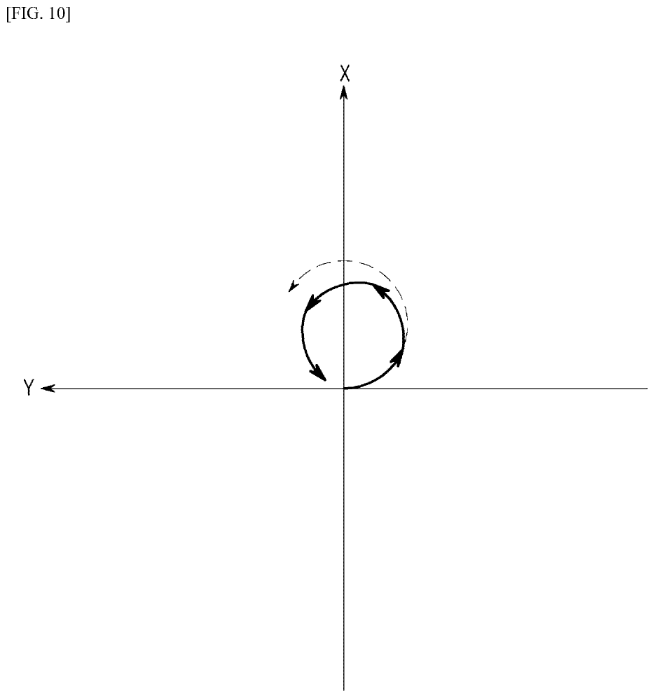

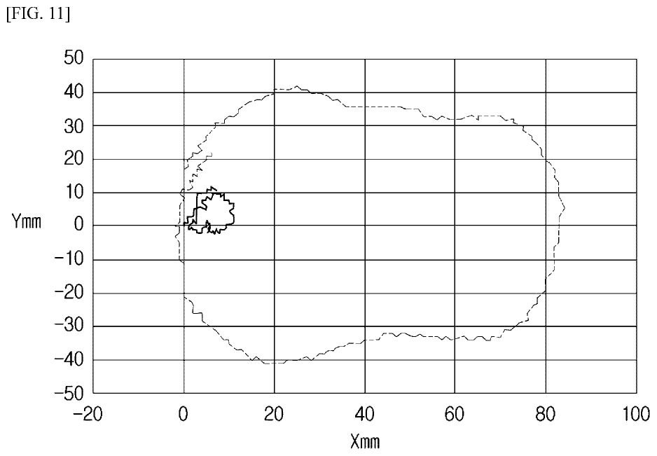

FIG. 8 is a view for describing a traveling trajectory when one pair of mopping cloths of a robot cleaner are rotated at the same rotation speed, FIG. 9 is a view for describing a trajectory of a robot cleaner traveling while drawing a spiral on a floor surface based on a method of controlling the robot cleaner according to an embodiment of the present disclosure, FIG. 10 is a schematic view for comparing traveling trajectories of FIGS. 8 and 9, and FIG. 11 shows a picture expressing traveling trajectories when a robot cleaner rotates one pair of mopping cloths at the same speed and when the mopping cloth located far from the origin of rotation is rotated fast.

Referring to FIGS. 8 through 11, an effect of the method of controlling the robot cleaner according to the present disclosure will be described as below.

When a part of the bottom surface of the robot cleaner 1 is rubbed against the floor surface B in a state where the pair of rotation plates 10 and 20 of the robot cleaner 1 are rotated at the same rotation speed, the rubbed part may become the new center O′ of rotation and the midpoint C, which is the existing center of rotation, may be moved drawing a circle around the new center O′ of rotation, when viewed from above the floor surface B (see FIG. 8).

In comparison with this, in the present disclosure, when rotation correction operation S30 is performed, the moving trajectory of the midpoint C may change. That is, when the distance between the origin O of rotation and the midpoint C increases, as the rotation plate located far from the origin O of rotation between the pair of rotation plates 10 and 20 is rotated faster than the rotation plate located close to the origin O of rotation, the trajectory of the midpoint C rotating drawing a circular arc around the new center O′ of rotation may be bent inward toward the origin O of rotation, thus converging to the origin O of rotation (see FIG. 9).

Consequently, in the robot cleaner 1 of the present disclosure, the midpoint C may move drawing a trajectory in a closed curve form on the floor surface B. In this case, the trajectory of the midpoint C may change according to deviating direction and degree from the origin O of rotation in the initial stage of rotary traveling.

For example, the midpoint C may move drawing a trajectory in a spiral form on the floor surface B.

In another example, the midpoint C may move drawing a trajectory in a flat circular form.

In another example, the midpoint C may move drawing a trajectory in a rugby ball form.

Comparing the trajectories of the midpoint C with reference to FIG. 10, in the initial stage of rotary traveling, in common, the midpoint C draws a trajectory similar to a circle around the new center O′ of rotation. Thereafter, as the rotation correction operation S30 is performed, in the robot cleaner 1 according to the present disclosure, the trajectory of the midpoint C is gradually drawn toward the origin O of rotation.

Meanwhile, referring to FIG. 11, a difference between a trajectory actually drawn by the midpoint C (indicated by a dotted line) and a trajectory drawn by the midpoint C according to the present disclosure (indicated by a solid line) when the pair of rotation plates 10 and 20 are rotated at the same rotation speed may be seen.

It may be seen that the trajectory drawn by the midpoint C has more variations in FIG. 11 than in FIG. 10.

First, when the pair of rotation plates 10 and 20 are rotated at the same rotation speed, as shown in FIG. 10, the midpoint C may rotate around the new center O′ of rotation and through such circular motion, a centrifugal force may be further generated in the robot cleaner. When the centrifugal force works outward from the new center O′ of rotation, the robot cleaner may slip due to a feature of the wet robot cleaner where a frictional force between the mopping cloths 30 and 40 and the floor surface B is not strong. As a result, it is difficult for the robot cleaner to travel at the same place as well as to make circular motion with respect to the new center O′ of rotation.

On the other hand, for the robot cleaner 1 to which the present disclosure is applied, even when the midpoint C moves drawing a circular arc around the new center O′ of rotation, the controller 110 may sense that the midpoint C moves away from the origin O of rotation, and thus quickly rotate the rotation plate located far from the origin O of rotation, thereby rapidly changing the moving trajectory of the robot cleaner 1. Moreover, in the present disclosure, as the midpoint C moves away from the origin O of rotation, a rotation speed difference between the pair of rotation plates 10 and 20 increases, such that the midpoint C may be rapidly returned to the origin O of rotation.

Therefore, as shown in FIG. 11, the robot cleaner 1 according to the present disclosure, when rotating once at the same place, may maintain a distance between the origin O of rotation and the midpoint C within about 10 mm and maintain the distance within at least about 20 mm.

Thus, the origin O of rotation may be continuously positioned perpendicularly under the body 50 when the body 50 rotates once at the same place. The distance between the origin O of rotation and the midpoint C may be maintained shorter than a distance between the midpoint C and the rotation axes 15 and 25.

This, when viewed by the user, may allow the user to recognize that the robot cleaner 1 rotates while being maintained at the same place.

According to the present disclosure described above, in rotary traveling at the same place with respect to the origin O of rotation, the rotation plate disposed far from the origin O of rotation may be rotated faster than the rotation plate disposed close to the origin O of rotation, thereby preventing the center of rotation of the robot cleaner 1 from moving away from the origin O of rotation.

Moreover, by minimizing the overall radius in which the robot cleaner 1 travels, the robot cleaner 1 may continuously clean a particular point requiring intensive cleaning without leaving the particular point.

Although the present disclosure has been described in detail through specific embodiments, it is intended to describe the present disclosure in detail, and the present disclosure is not limited thereto, and it is apparent that the present disclosure may be modified or improved by those of ordinary skill in the art within the technical spirit of the present disclosure.

All simple modifications and variations of the present disclosure fall within the scope of the present disclosure, and the specific protection range of the present disclosure will be made clear by the appended claims.

1.-14. (canceled)

15. A robot cleaner comprising:
a body having a space therein to accommodate a battery, a water container, and a motor;
a pair of rotation plates rotatably arranged on a bottom surface of the body, each rotation plate among the pair of rotation plates including a lower side coupled to a mop, each mop being configured to face a floor surface; and
a virtual connection line connecting axes of rotation of the pair of rotation plates to each other,
wherein in rotary traveling of the robot cleaner, a midpoint of the virtual connection line moves on the floor surface.

16. The robot cleaner of claim 15, wherein the midpoint of the virtual connection line moves in a spiral trajectory on the floor surface.

17. The robot cleaner of claim 15, wherein the midpoint of the virtual connection line moves in a flat circular trajectory on the floor surface.

18. The robot cleaner of claim 15, wherein the midpoint of the virtual connection line moves in an oval trajectory on the floor surface.

19. A robot cleaner comprising:
a body having a space therein to accommodate a battery and a water container;
a pair of rotation plates including mopping cloths coupled to lower sides thereof and facing a floor surface, the pair of rotation plates being rotatably disposed on a bottom surface of the body; and
a virtual connection line connecting axes of rotation of the pair of rotation plates to each other,
wherein a midpoint of the virtual connection line is an origin of rotation at a start of rotary traveling of the robot cleaner.

20. The robot cleaner of claim 19, wherein the midpoint of the virtual connection line is located in the origin of rotation at the start of rotary traveling, and
wherein in rotary traveling, a distance between the origin of rotation and the midpoint of the virtual connection line is maintained to be shorter than a distance between the midpoint of the virtual connection line and axes of rotation of the pair of rotation plates.

21. The robot cleaner of claim 20, further comprising a controller configured to determine, in rotary traveling, whether an axis of rotation of the robot cleaner deviates from the origin of rotation by determining whether the midpoint of the virtual connection line moves away from the origin of rotation.

22. The robot cleaner of claim 21, wherein in a rotation correction operation, the controller is configured to control a first rotation plate among the pair of rotation plates that is located furthest from the origin of rotation to rotate faster than a second rotation plate among the pair of rotation plates.

23. The robot cleaner of claim 22, further comprising:
a first motor connected to the first rotation plate; and
a second motor connected to the second rotation plate,
wherein the controller is configured to control, in the rotation correction operation, an output of the first motor to be greater than an output of the second motor.

24. The robot cleaner of claim 22, wherein a rotational speed difference between the first rotation plate located furthest from the origin of rotation and the second rotation plate located closest to the origin of rotation increases as a distance between the origin of rotation and the midpoint of the virtual connection line increases.

25. The robot cleaner of claim 19, wherein the pair of rotation plates have a same rotational direction and different rotational speeds.

26. The robot cleaner of claim 19, wherein the midpoint of the virtual connection line moves on the floor surface in one of a spiral trajectory, a flat circular trajectory and an oval trajectory.

27. A method of controlling a robot cleaner, the robot cleaner including a body and a pair of rotation plates having lower sides coupled to mopping cloths configured to face a floor surface, the robot cleaner traveling by rotation of the pair of rotation plates, the method comprising:
a rotary traveling operation of causing the robot cleaner to perform rotary traveling by controlling a rotation of the pair of rotation plates; and
a rotation correction operation of rotating the pair of rotation plates at different rotational speeds.

28. The method of claim 27, wherein in the rotary traveling operation, the pair of rotation plates are rotated in a same direction.

29. The method of claim 27, wherein in the rotary traveling operation, the pair of rotation plates are rotated at a same speed.

30. The method of claim 27, further comprising a deviation determination operation of determining whether the robot cleaner deviates from a position corresponding to a start of rotation.

31. The method of claim 27, wherein in the rotation correction operation, a rotational speed difference between the pair of rotation plates is increased as the robot cleaner moves away from a position corresponding to a start of rotary traveling.

32. The method of claim 27, wherein the controller is configured to control, in the rotation correction operation, a first rotation plate among the pair of rotation plates that is located furthest from an origin of rotation to rotate faster than a second rotation plate among the pair of rotation plates.

33. The method of claim 32, wherein the robot cleaner further includes:
a first motor connected to the first rotation plate; and
a second motor connected to the second rotation plate, and
wherein in the rotation correction operation, an output of the first motor is controlled to be greater than an output of the second motor.

34. The method of claim 32, wherein the rotation correction operation continues to increase a rotation speed of the first rotation plate located furthest from the origin of rotation to be faster and to decrease a rotation speed of the second rotation plate located closest from the origin of rotation until the midpoint of the virtual connection line is at a same location as the origin of rotation.
